(19) United States
(12) Patent Application Publication
(10) Pub. No.: US 2024/0347293 A1
(43) Pub. Date: Oct. 17, 2024

(54) SWITCHING APPARATUS AND METHOD FOR DELIVERY OF HIGH CURRENTS AND HIGH VOLTAGES

(71) Applicants: Ashlin Hickman, Fargo, ND (US); Orlando Ekici, Fargo, ND (US); Gage Koskovich, Fargo, ND (US)

(72) Inventors: Ashlin Hickman, Fargo, ND (US); Orlando Ekici, Fargo, ND (US); Gage Koskovich, Fargo, ND (US)

(21) Appl. No.: 18/633,470

(22) Filed: Apr. 11, 2024

Related U.S. Application Data
(60) Provisional application No. 63/495,699, filed on Apr. 12, 2023.

(51) Int. Cl. H01H 33/22; H01H 33/06; H01H 33/42

(52) U.S. Cl. CPC H01H 33/22; H01H 33/06; H01H 33/42

(57) ABSTRACT

A switch comprising an insulator door that allows or disallows power transmission between two or more electrodes. When the insulator door is “open,” with sufficiently high voltage, an arc forms between the two or more electrodes facilitating transmission of power by means of the arc. When the insulator door is “closed,” the insulative properties of the insulator door block the path of power transmission.

### PRIORITY CLAIM

The present application claims priority to U.S. Provisional Application Ser. No. 63/495,699 filed on Apr. 12, 2023 entitled “Switching Apparatus And Method For Delivery Of High Currents And High Voltages” which is incorporated herein by reference in its entirety.

### FIELD OF THE TECHNOLOGY

The present technology relates to the control of power delivery in high voltage systems, and more specifically to switching devices capable of delivering high currents and high voltages.

### BACKGROUND OF THE TECHNOLOGY AND RELATED ART

Most high voltage power delivery systems are either very inefficient or fail in high current applications. Specialized systems designed to handle high current and high voltage efficiently are expensive.

High-voltage relays can serve as a suitable alternative to specialized systems. However, high-voltage relays can still be expensive, inefficient, and difficult to control-particularly when turning the high-voltage relays on and off. One reason it can be difficult to control a high-voltage relay is that an arc can form as the electrical contacts open and close. Relay-based switches use air as an insulator. The insulator in a relay can be overcome as the relay is closing, resulting in an arc forming. During operation of relay-based switches, conductive contacts touch each other momentarily. When these contacts touch, a higher current is passed through the relay causing the contacts to become extremely hot. This extreme heat can cause the contacts to become fused together, locking the relay in a closed state.

Another alternative is silicon-based high-voltage transistors, which are more efficient and easier to control. However, silicon-based high-voltage transistors can be destroyed by high currents and high heat.

### BRIEF DESCRIPTION OF THE DRAWINGS

The present technology will become more fully apparent from the following description and appended claims, taken in conjunction with the accompanying drawings. Understanding that these drawings merely depict exemplary aspects of the present technology, they are therefore not to be considered limiting of its scope. It will be readily appreciated that the components of the present technology, as generally described and illustrated in the drawings herein, could be arranged and designed in a wide variety of different configurations. Nonetheless, the technology will be described and explained with additional specificity and detail through the use of the accompanying drawings in which:

FIG. 1 is a front isometric view of a switching apparatus according to one aspect of the technology.

FIG. 2 is a rear isometric view of a switching apparatus according to one aspect of the technology.

FIG. 3 is an exploded perspective view of a switching apparatus depicting components according to one aspect of the technology.

FIG. 4 is a frontal elevational view of an insulator disc according to one aspect of the technology.

FIG. 5 is a side elevational view of one aspect of the insulator disc of FIG. 4.

FIG. 6 is a depiction of one aspect of a rotary door in an “ON” state.

FIG. 7 is a depiction of one aspect of a rotary door in an “OFF” state.

FIG. 8 is a top view of a switching apparatus according to one aspect of the technology.

FIG. 9 is an exploded side elevational view of the alignment of an insulator disc according to one aspect of the technology.

FIG. 10 is an exploded perspective view of a switching apparatus according to one aspect of the technology.

FIG. 11 discloses elevational side and top views of a switching apparatus according to one aspect of the technology.

FIG. 12 is a circuit diagram comprising a switching apparatus according to one aspect of the technology.

FIG. 13 is a side view of an insulator disc according to one aspect of the technology.

FIG. 14 is a front isometric view of a switching apparatus according to one aspect of the technology.

FIG. 15 is side and top elevational views of a switching apparatus according to one aspect of the technology.

FIG. 16 is an exploded perspective view of a switching apparatus depicting components according to one aspect of the technology.

FIG. 17 is depictions of aspects of a switching apparatus in an “ON” state and in an “OFF” state.

### DETAILED DESCRIPTION

The following detailed description of exemplary aspects of the technology refers to the accompanying drawings, which form a part hereof and in which are shown, by way of illustration, exemplary aspects in which the technology may be practiced. While these exemplary aspects are described in sufficient detail to enable those skilled in the art to practice the technology, other aspects may be realized and various changes to the technology may be made without departing from the spirit and scope of the present technology. Thus, the following more detailed description of the aspects of the present technology is not intended to limit the scope of the technology, as claimed, but is presented for purposes of illustration only and not as a limitation, but to describe the features and characteristics of the present technology and to sufficiently enable one skilled in the art to practice the technology. Accordingly, the scope of the present technology is to be defined solely by the appended claims.

As used in this specification and the appended claims, the singular forms “a,” “an” and “the” include plural referents unless the context clearly dictates otherwise. Thus, for example, reference to “a line” includes a plurality of such lines. In this disclosure, “comprises,” “comprising,” “containing” and “having” and the like can have the meaning ascribed to them in U.S. Patent law and can mean “includes,” “including,” and the like, and are generally interpreted to be open ended terms.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in any manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

The terms “disc” and “door” are used interchangeably to refer to the insulator element that allows or disallows power transmission across a switch. In some aspects, the “disc” or “door” rotates, i.e. “rotary door.” In other aspects, the “door” does not rotate.

The following detailed description and exemplary aspects of the technology will be best understood by reference to the accompanying drawings, wherein the elements and features of the technology are designated by numerals throughout.

The present technology describes a switch comprising an insulator door that allows or disallows power transmission across two electrodes separated by a gap. When the insulator door is “open,” with sufficiently high voltage (i.e., the breakdown voltage), the gas or air between the electrodes ionizes creating a conductive path (i.e., an arc) between the two or more electrodes facilitating transmission of power (power=current×voltage) by means of the arc. When the insulator door is “closed,” the insulative properties of the insulator door block the path of power transmission.

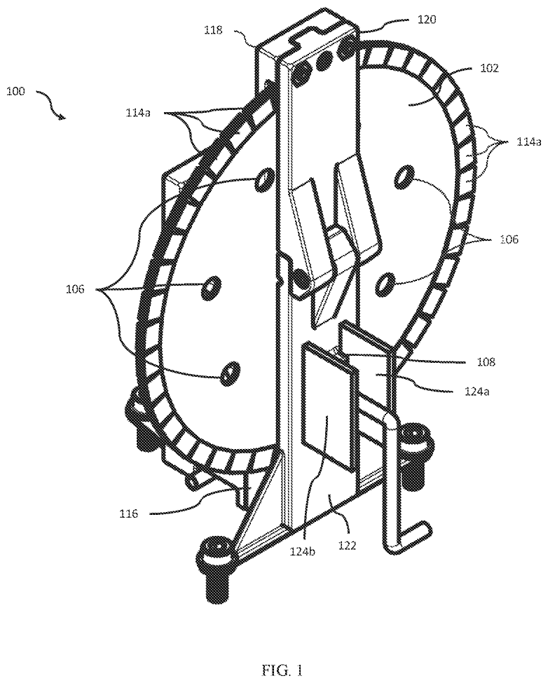

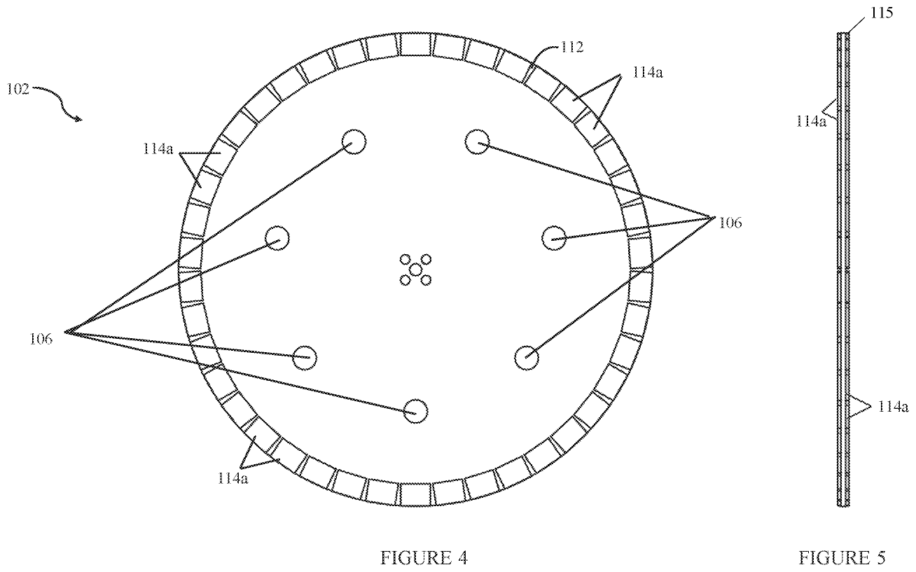

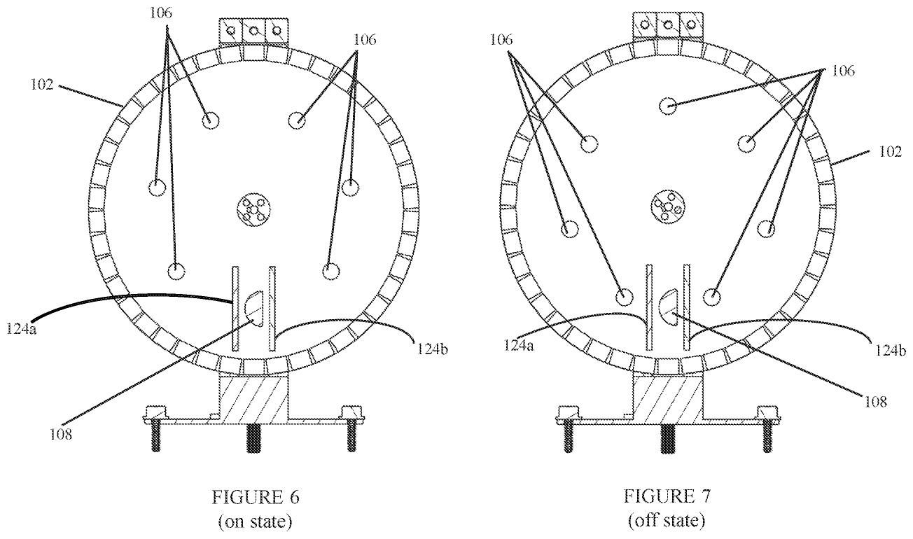

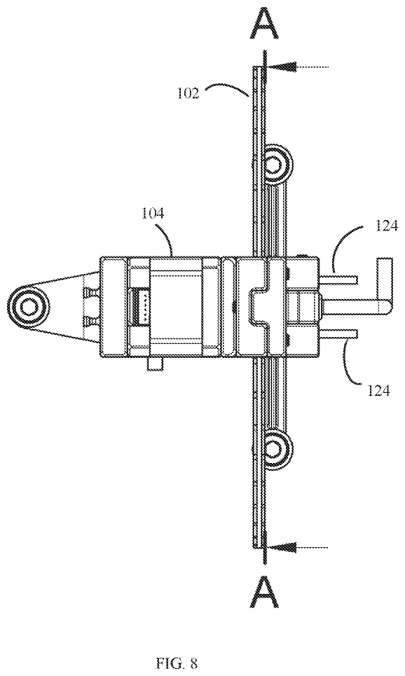

With reference generally to FIGS. 1-10 and specifically to FIGS. 6 and 7, in some aspects, the insulator door comprises a disc 102 having one or more apertures or openings 106. “Openings” refers to holes, gaps, or spaces through which power may be transmitted through the insulator disc 102. The insulator disc 102 is rotated by way of an attached motor 104. As the insulator disc 102 rotates, the openings 106 in the disc expose the two electrodes 108, 110 to each other (the “on” state). With sufficiently high voltage, an arc forms between the two electrodes 108, 110, facilitating transmission of power by means of the arc. As the insulator disc 102 continues to rotate, the insulative properties of the disc 102 block the path of power transmission (the “off” state) extinguishing the arc. As the disc 102 continues to rotate, alignment of the electrodes 108, 110 with the next opening 106 in the disc 102 re-establishes the arc restoring power transmission (the “on” state). The transmission of power across the switch 100 in this fashion provides pulsed power, i.e., a voltage pulse, to a connected load. The switch 100 can utilize DC, AC, or three-phase voltage to generate a voltage pulse.

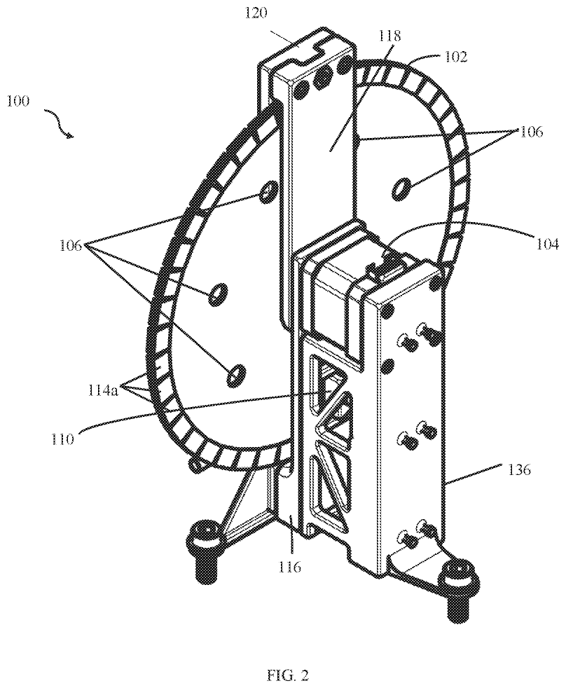

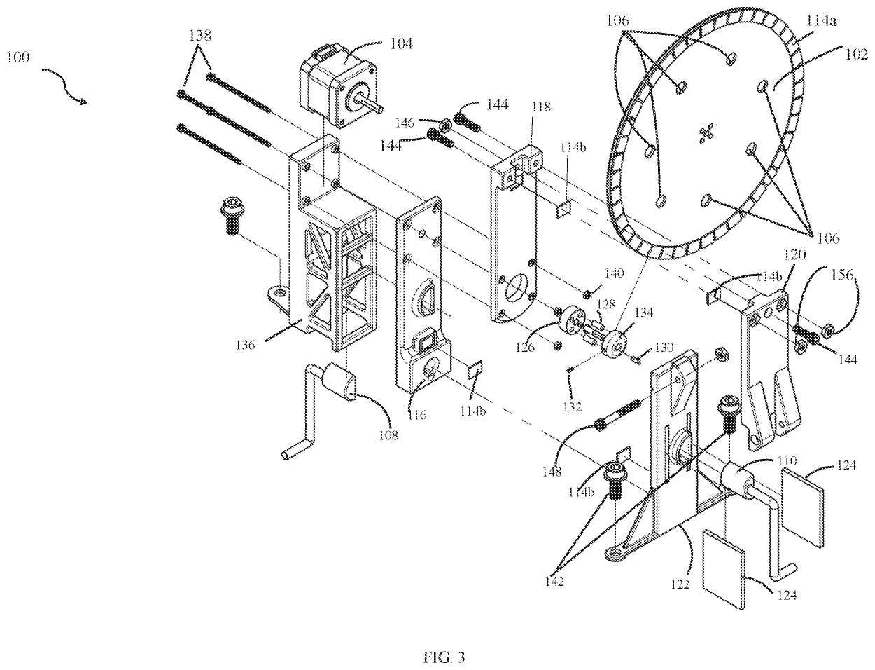

FIG. 1 discloses a front isometric view of one aspect of a switching apparatus. FIG. 2 discloses a back isometric view of a switching apparatus shown in FIG. 1. FIG. 8 discloses a top view of the switching apparatus shown in FIG. 1. And FIG. 3 discloses an exploded view of the switching apparatus disclosed in FIG. 1.

With reference to FIG. 3, a switching apparatus 100 may be assembled in an upright position where the insulator disc 102 is perpendicular to the ground. However, a switching apparatus, according to the technology, is not limited to any specific orientation. For example, a switching apparatus may be assembled such that the insulator disc 102 is parallel to the ground. The insulator disc 102 is also referred to as a “rotary door.” The shape of the insulator disc is also not limited to any one geometry. For example, the shape of the insulator disc may comprise any shape, including circles, polygons, decagons, octagons, etc.

The insulator disc 102 has one or more openings 106. The openings 106 are generally larger than the diameter of the one or more electrode pairs 108, 110. This minimizes heat from the arc from degrading the inner sides of the openings 106. For the current to pass through the openings 106, there needs to be enough space for the arc. Under standard atmospheric conditions (e.g., 1 atm), the electric arc can sustain a current density of 1 MA/cm². In one aspect, the size of the electrodes could be selected such that they can safely handle the RMS (Root Mean Square) current, and the opening size could then be double the diameter of the selected electrodes.

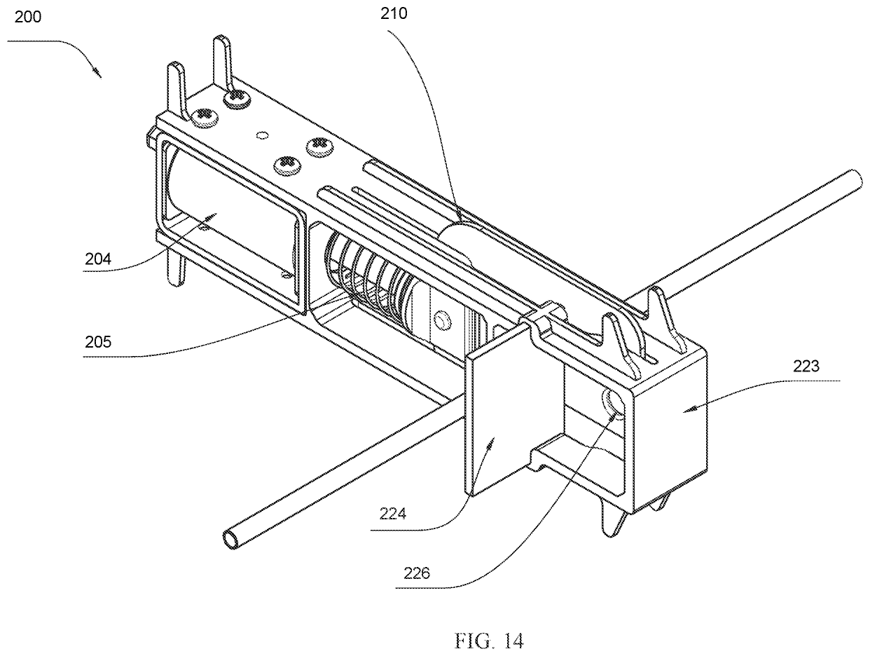

The openings 106 are also not limited to any one geometry. The openings 106 may comprise any shape, including circles, squares, triangles, half-circles, crescents, hexagons, etc. With reference to FIG. 13, the openings 106 are also not limited to any one location on the insulator door 102. For example, the insulator disc 102 may include openings 106 around the perimeter of the disc 102. However, the openings 106 must be separated sufficiently for the switch to function. For example, in air at standard conditions (STP), 1 volt would require a minimum hole spacing of ⅓ μm. This minimum hole spacing increases with increased voltage and temperature and decreases with increasing pressure and fluid dielectric strength.

Referring again to FIG. 3, in this example, the disc 102 has seven holes 106 through which power may be transmitted when any of the holes 106 are aligned with electrodes 108, 110. During operation, the disc 102 revolves around the axis of a motor 104. In accordance with the technology, any motor or combination of motors and/or gear boxes could be used. In some aspects, the motor 104 may comprise brushless DC motors, brushed DC motors, synchronous motors, induction motors, AC motors, three-phase motors, stepper motors, and linear motors. In other aspects of the technology, the rotor of the motor could be designed to also function as the insulator disc 102. In another aspect, actuation of the insulator door 102 may comprise solenoids, pneumatics, and other forms of actuation.

With reference to FIGS. 6 and 7, as the motor 104 is controlled, it rotates the disc 102 between two states: “on” (as disclosed in FIG. 6) and “off” (as disclosed in FIG. 7). In the “on” state, the disc 102 is rotated until one of the holes 106 aligns with the electrode pair 108, 110, exposing the electrodes, 108, 110 to each other. In the “off” state, the disc 102 has been rotated until one of the holes 106 no longer aligns with the electrode pair 108, 110, thereby blocking the path of power transmission.

The gap between the electrodes 108, 110 allows sufficient proximity between the electrodes 108, 110 such that with sufficiently high voltage (i.e., the breakdown voltage), an arc forms when the device is in the “on” state. As an example, the gap between the electrodes could range between 0.02 mm and up to 1 meter. However, the size of the gap depends on several factors, including: (a) the amount of power to be supplied through the switch 100; (b) the diameter, thickness, shape, composition, and insulating properties of the disc 102; (c) the size, shape, composition, orientation, and number of openings 106; (d) atmospheric conditions (e.g., temperature and pressure); and (e) the thermal expansion of the electrodes, which could cause the electrodes to come into contact with one another and potentially weld together.

As the voltage increases, the electric field strength between the conductive materials (e.g., electrodes) increases, making it easier for electrical breakdown to occur. Similarly, at higher temperatures, air molecules gain energy and move more freely, making them more susceptible to ionization and breakdown. Higher pressure compresses air molecules closer together, reducing the distance and increasing ionization energy over which the electric field acts. This decreased distance increases the likelihood of electrical breakdown while increasing the breakdown voltage. The dielectric strength of a fluid (e.g., air) is its ability to withstand electrical stress without breaking down. If the dielectric strength of the fluid decreases, it becomes easier for breakdown to occur, requiring a larger separation distance between conductive surfaces (e.g., electrodes) to prevent arcing.

In some aspects, the openings 106 may be filled with air or some other compressible or non-compressible fluid (e.g., argon, krypton, xenon, sulfur hexafluoride (SF6), carbon dioxide, hydrocarbons, hydrogen, carbon monoxide, etc.). In other aspects, a conductive material (e.g., copper, silver, gold, aluminum, iron, mercury, nickel-silver alloy, platinum, tungsten, etc.) may be disposed within the openings, or the openings may be completely filled in with a conductive material. In other aspects, a second insulator may be disposed in the openings (e.g., between an edge of the openings and an edge of the conductive material.).

In other aspects, a larger gap between the electrodes may be desired. For example, when discharging an inductor, a larger gap may be required to ensure that the inductor discharges at a high voltage, significantly increasing the rate of discharge.

The speed at which the switch 100 may be operated is determined by the several factors, including: (a) the amount of torque the motor 104 can supply; (b) the diameter, thickness, shape, composition, weight, and insulating properties of the disc 102; (c) the size, shape, composition, orientation, and number of openings 106; (d) the frequency at which the disc 102 will start to resonate (potentially causing damage to the switch 100); and (e) the rate at which voltage can be supplied to the electrodes 108, 110 (e.g., how quickly a capacitor bank can charge and discharge).

As an example, the duration of the voltage pulse can be between 5 nanoseconds and 60 seconds. However, approaching 60 seconds it is expected that the electrodes may begin to melt depending on their composition. As another example, the voltage pulse can be repeated between 0.0167 and 30,000,000 times per second. The voltage across the switch can be between 1 volt and 5 megavolts. And the current across the switch can be between 0.01 A/cm² and 1,000,000 A/cm².

In one aspect, the insulator door 102 comprises a combination of materials, including: (a) one or more insulators (e.g., glass, ceramic glass, fused silica quartz, ceramics, silica ceramics, zeolites, aerogels, alumina, rubber, silicone, plastics, polyvinyl chloride, polyethylene, polytetrafluoroethylene, etc.); (b) composite materials (e.g., fiberglass, carbon fiber reinforced polymer, Kevlar, aluminum matrix composites, etc.); and/or (c) conductive materials coated with an electrically insulating polymer (e.g., polyethylene, polypropylene, polyvinyl chloride, polytetrafluoroethylene, polyimide, epoxy resins, etc.).

The insulator door 102 has one or more openings 106 through which power may be transmitted when the one or more openings 106 are aligned with the one or more electrode pairs 108, 110. In some aspects, the openings 106 may merely allow the surrounding air to pass through. In other aspects, a conductive material (e.g., copper, silver, gold, aluminum, iron, mercury, nickel-silver alloy, platinum, tungsten, etc.) may be disposed in the openings 106.

Referring again to FIG. 3, the insulator disc 102 may comprise one or more magnets 114a on the front and back faces of the disc 102. For example, FIGS. 3-5 disclose an insulator disc 102 comprising a ring of magnets 114a on the front and back faces of the disc 102 along an outer edge of the disc 102. The switch 100 also includes a switch frame assembly having a rear electrode post 116, a rear magnet post 118, a front magnet post 120, and a front electrode post 122. The frame assembly straddles the insulator disc 102. The rear electrode post 116, the rear magnet post 118, the front magnet post 120, and the front electrode post 122 each include a magnet 114b.

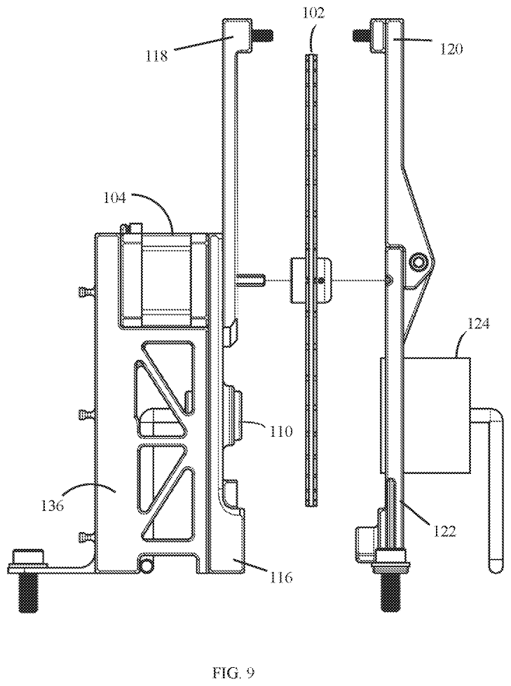

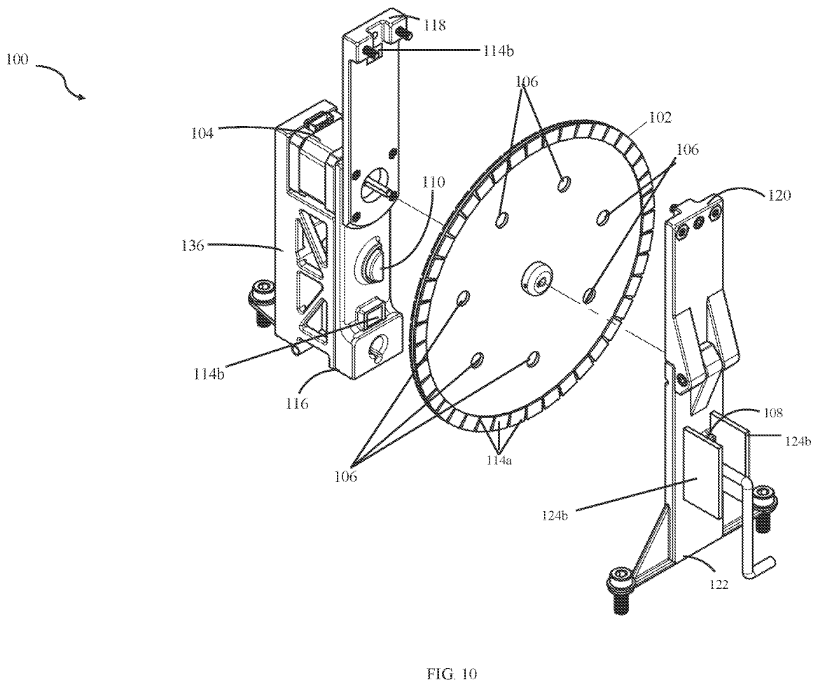

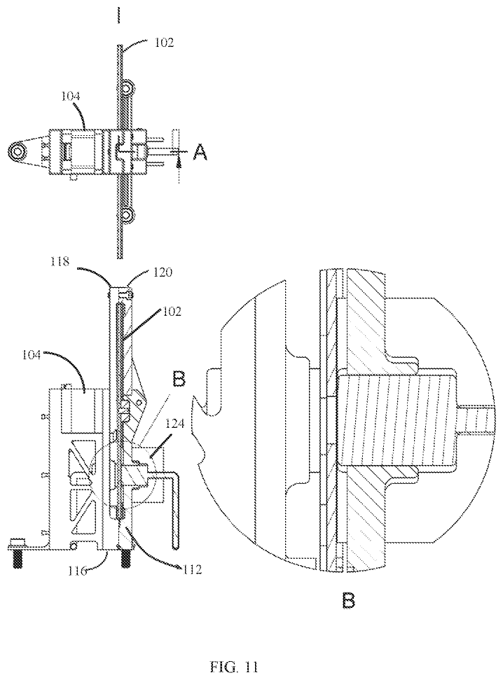

On the assembled switch 100, the magnets 114b on the switch frame assembly align with the ring of magnets 114a on the insulator disc 102. In one aspect, the magnets 114a, 114b are equidistant from one another, as disclosed in FIGS. 9 and 10, although in another aspect they are not equidistant.

With reference to FIG. 8, when the switch is operating, the magnetic forces between the magnets 114b on the switch frame assembly and the magnets 114a on the disc 102 help maintain the alignment (A) of the disc 102. FIGS. 9 and 10 disclose an exploded side elevational view of the magnetic alignment of the disc 102.

Referring again to FIG. 3, the switch 100 has two vertical insulating plates 124 that are positioned on the right and left sides of the front electrode 108 with a small gap (e.g., 0.1 mm to 1 mm) between the insulating plates 124 and the disc 102. The insulating plates 124 may comprise a combination of materials, including: (a) one or more insulators (e.g., glass, ceramic glass, fused silica quartz, ceramics, silica ceramics, zeolites, aerogels, alumina, rubber, silicone, plastics, polyvinyl chloride, polyethylene, polytetrafluoroethylene, etc.); (b) composite materials (e.g., fiberglass, carbon fiber reinforced polymer, Kevlar, aluminum matrix composites, etc.); and/or (c) conductive materials coated with an electrically insulating polymer (e.g., polyethylene, polypropylene, polyvinyl chloride, polytetrafluoroethylene, polyimide, epoxy resins, etc.).

Vertical insulating plates 124 may also be positioned on right and left sides of the rear electrode 110. Horizontal insulating plates 124 may also be positioned above and below the front and rear electrodes 108, 110. The insulating plates 124 further insulate the electrodes 108, 110 minimizing an arc from forming outside the intended location during operation-the intended location being through the openings in the insulator door, e.g., through the holes 106 in the disc 102.

In another aspect, the switch 100 includes one or more insulating electrode enclosures comprising several insulation plates 124 with one or more openings between the electrodes and the insulator door. The one or more insulating electrode enclosures has a small gap (e.g., 0.1 mm to 1 mm) between the insulating electrode enclosures and the insulator door.

In another aspect, the switch 100 includes one more insulating tubes with one or more openings between the electrodes and the insulator door. The one or more insulating tubes also has a small gap (e.g., 0.1 mm to 1 mm) between the insulating electrode tubes and the insulator door.

The insulating plates 124, insulating electrode enclosures, and insulating tubes all serve as thermal and electrical insulators, minimizing deterioration of the materials around the electrodes 108, 110. FIGS. 1, 8-10 illustrate one aspect of the positioning of the insulating plates 124.

Referring again to FIG. 3, a spacer plate 126, disc cross pins 128, compression bar 130, set screw 132, and plate retainer 134 are used to center secure the disc 102 to the drive motor 104, the assembly and alignment of which is illustrated in FIG. 10. The drive motor 104 is secured to a motor chair 136 on the back side of the switch frame assembly. More specifically, the motor chair 136 is secured to the rear electrode post 116 and the rear magnet post 118 by frame screws 138 and hex nuts 140. The rear electrode 110 is secured to the rear electrode post 116. The front electrode 108 is secured to the front electrode post 122. Screws 144 and nuts 146 secure the rear magnet post 118 to the front magnet post 120 along a top portion of the magnet posts 118, 120. The switch 100 further includes one or more grounding bolts 142.

FIG. 11 shows elevational side and top views of the switch 100 in FIG. 3 assembled. FIG. 11 further shows the alignment (A) of the driver motor 104 and the insulator disc 102.

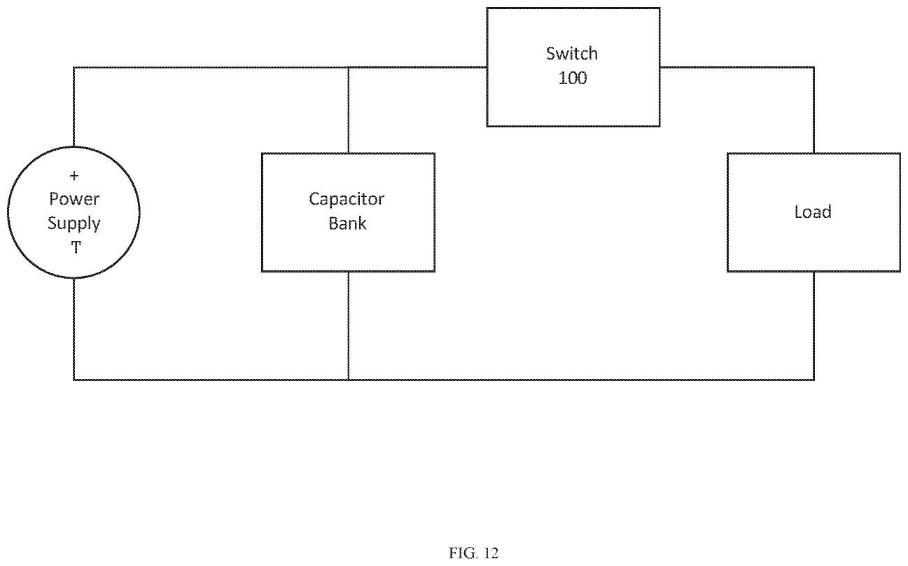

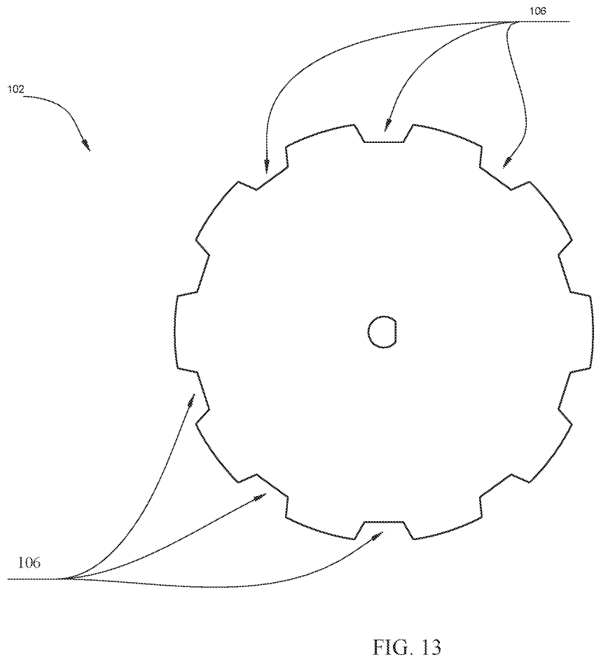

FIG. 12 shows a simplified circuit diagram comprising a power supply, a capacitor bank, a switching apparatus 100, and a load according to one aspect of the technology.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications, combination of features, or changes, if any, are intended to fall within the scope of the present technology as described and set forth herein. In addition, while specific features are shown or described as used in connection with particular aspects of the technology, it is understood that different features may be combined and used with different aspects. Likewise, numerous features from various aspects of the technology described herein may be combined in any number of variations as suits a particular purpose.

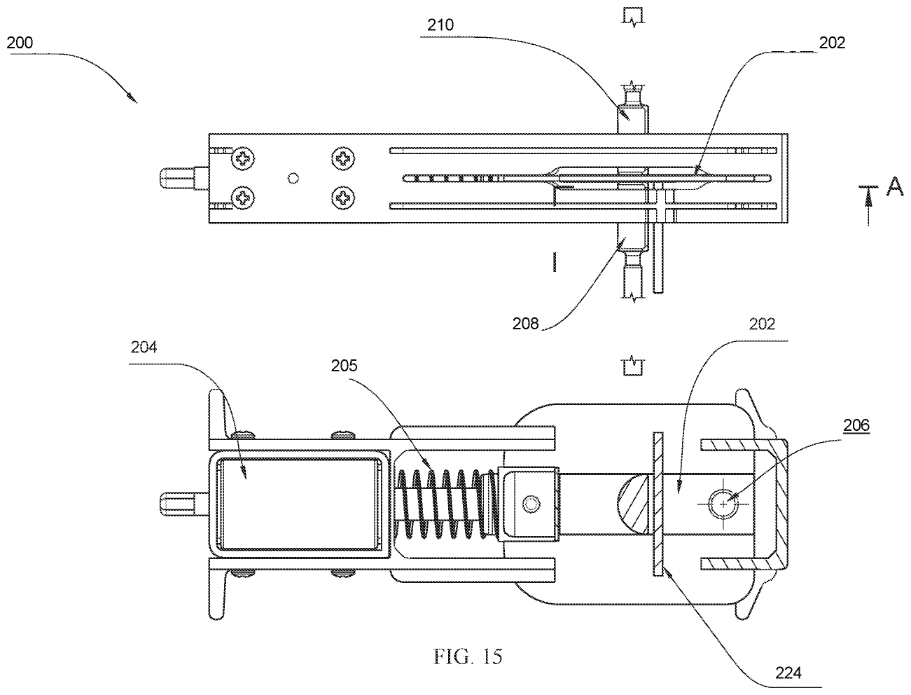

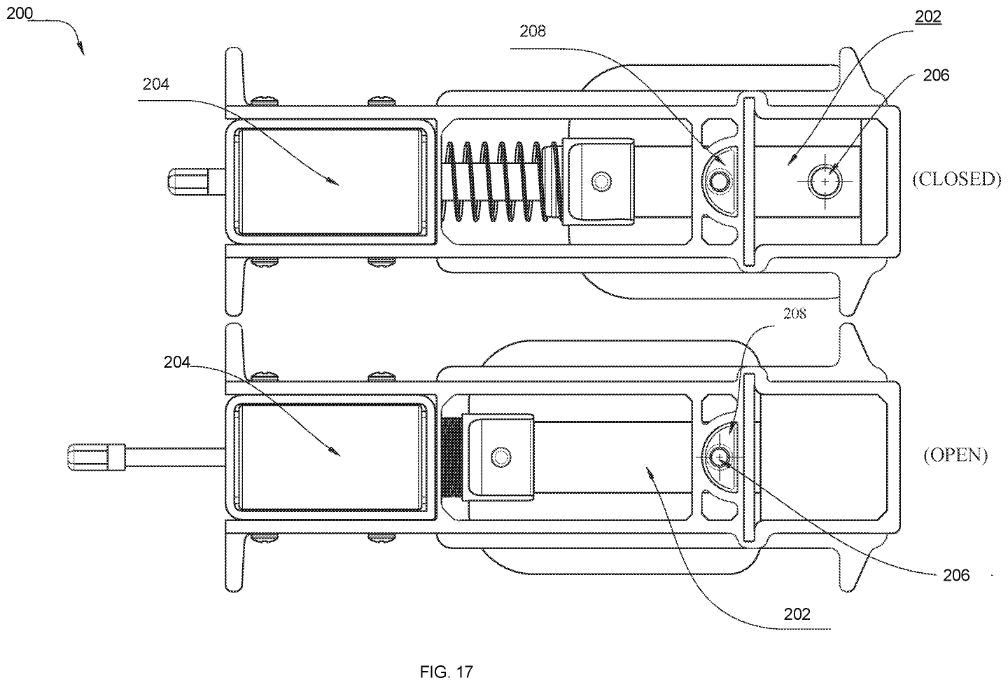

For example, with reference generally to FIGS. 14-17, the switch 200 may comprise a frame assembly, 223, a solenoid 204, a spring 205, an insulator door 202 having one or more openings 206, and one or more electrode pairs 208, 210 separated by a gap. The solenoid 204 and spring 205 actuate the insulator door 202 between the one or more electrode pairs 208, 210 within the gap. With specific reference to FIG. 17, when the switch 200 is open (the “on” state), the one or more openings 206 is aligned with the one or more electrode pairs 208, 210 exposing the one or more electrode pairs 208, 210 to each other. When the switch 200 is closed (the “off” state), the one or more openings 206 are not aligned with the one or more electrode pairs 208, 210 blocking the path of power transmission across the one or more electrode pairs 208, 210.

As the solenoid 204 and spring 205 continue to actuate the insulator door 202 from the “off” state to the “on” state and from the “on” state to the “off” state, the transmission of power across the switch provides pulsed power, i.e., a voltage pulse, to a connected load.

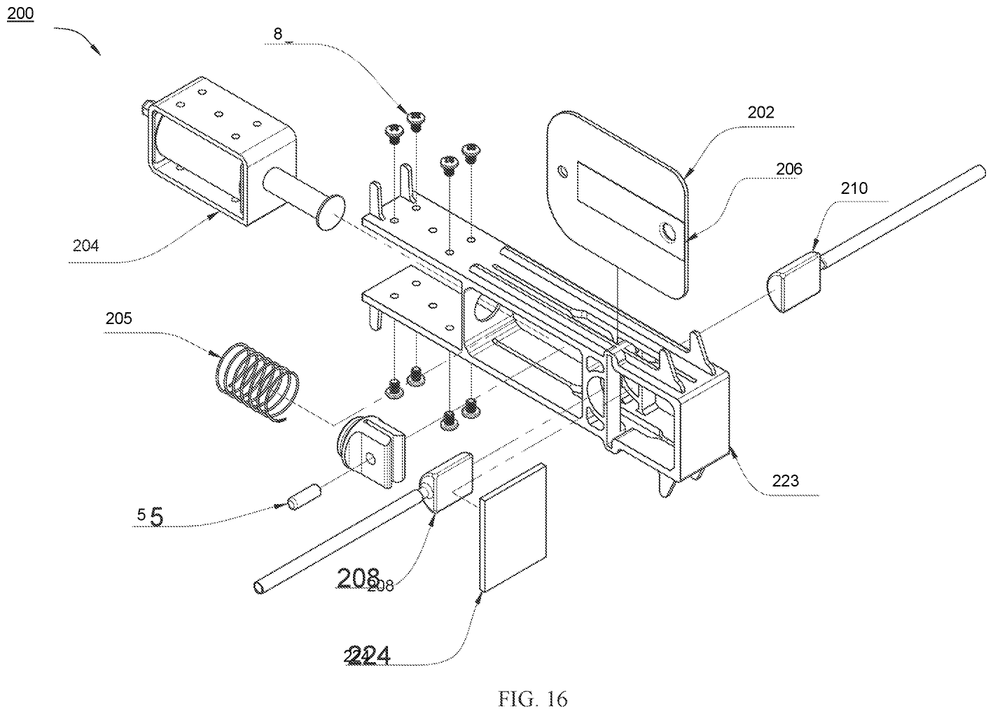

Referring again to FIG. 16, the switch 200 has one or more vertical insulating plates 224 that are positioned on the right and/or left sides of the one or more electrode pairs 108, 110 with a small gap (e.g., 0.1 mm to 1 mm) between the one or more insulating plates 224 and the insulator door 202. The insulating plate 224 may comprise a combination of materials, including: (a) one or more insulators (e.g., glass, ceramic glass, fused silica quartz, ceramics, silica ceramics, zeolites, aerogels, alumina, rubber, silicone, plastics, polyvinyl chloride, polyethylene, polytetrafluoroethylene, etc.); (b) composite materials (e.g., fiberglass, carbon fiber reinforced polymer, Kevlar, aluminum matrix composites, etc.); and/or (c) conductive materials coated with an electrically insulating polymer (e.g., polyethylene, polypropylene, polyvinyl chloride, polytetrafluoroethylene, polyimide, epoxy resins, etc.). The purpose of the one or more insulating plates 224 is to further electrically and thermally insulate the one or more electrode pairs 208, 210 minimizing an arc from forming outside the intended location during operation.

As additional examples, the switch can utilize DC, AC, or three-phase voltage to generate a voltage pulse. The switch can be operably connected to a DC, AC, or three-phase voltage source. The switch can be operably connected to a power source that uses three-phase electrical power. The switch can be configured to supply power at the peaks of an AC voltage source. The switch can trigger the discharge of a high-voltage capacitor bank within the circuit. The switch can further include a computer control. The computer control can be operable to select the duration and frequency of the voltage pulse.

The switch may also be encased in an insulating enclosure and filled with a compressible or non-compressible fluid having a different electrical conductivity than normal air (which is primarily composed of nitrogen and oxygen). For example, the switch may comprise a dielectric gas having a breakdown voltage relative to dry air of approximately 0.2 to 4 (e.g., argon, krypton, xenon, sulfur hexafluoride (SF6), carbon dioxide, hydrocarbons, hydrogen, carbon monoxide, etc.). And the insulator door of the encased switch may have a conductive material (e.g., copper, silver, gold, aluminum, iron, mercury, etc.) disposed within the openings. The insulating enclosure may further include sound deadening materials (e.g., acoustic foam, mass loaded vinyl (MLV), fiberglass insulation, cork, sound-proofing sealant, rubber, etc.).

As another example, the switch may be cooled by a cooling device, including air coolers, liquid coolers, thermoelectric coolers, phase-change coolers, heat pipes, cryogenics, or a hybrid cooling system.

As another example, the switch 101 may further comprise one or more Hall sensors to measure the position and speed of the insulator disc 102. A Hall sensor, also known as a Hall effect sensor, is a device that detects the presence or absence of a magnetic field. It works based on the Hall effect, which is the production of a voltage difference (Hall voltage) across an electrical conductor when subjected to a magnetic field perpendicular to the current flow. Hall sensors are typically composed of a thin semiconductor material, often made of gallium arsenide or indium arsenide, through which current flows. When a magnetic field is applied perpendicular to the direction of current flow, the Lorentz force causes the charge carriers to be deflected to one side of the conductor, creating a voltage difference perpendicular to both the current flow and the magnetic field. The voltage difference is measured by the Hall sensor and can be used to determine the strength and polarity of the magnetic field.

As another example, the insulating disc 102 may further comprises additional structural supports, including, by way of example, a metal ring around the outside edge 115 of the disc 102.

The technology disclosed herein has several useful applications. High voltage and current pulses can be used in various applications across several different fields. For example, these pulses can be used in pulse power systems for various industrial and scientific applications, such as pulsed lasers, electromagnetic forming, and pulse welding. In these systems, the high voltage and current pulses are used to deliver concentrated energy in short durations, enabling processes like material shaping, cutting, and welding.

High voltage, high current pulses can also be utilized in particle accelerators to accelerate charged particles to high energies. These accelerators are used for research in fields such as nuclear physics, particle physics, and materials science.

High voltage, high current pulses are also required in various types of pulse power supplies, such as those used in radar systems, pulsed power lasers, and high-power microwave systems. These provide the necessary energy for generating and amplifying electromagnetic waves used in communication, sensing, and defense applications.

High voltage, high current pulses are also used in electrical testing and measurement applications, such as impulse voltage testing of electrical insulation and components, as well as in transient response testing of electronic devices.

High voltage pulses are employed to generate magnetic fields in magnetic resonance imaging (MRI) systems.

High voltage pulses are used to generate plasma for sterilizing medical equipment and surfaces.

High voltage pulses are used in dynamic voltage restorers (DVRs) to mitigate voltage sags and disturbances in electrical grids, ensuring stable power supply to sensitive equipment and industries.

High voltage and current pulses can also be used in the manufacture of graphene. It is a rapid, scalable, and low-cost approach that involves converting any carbon-containing material into graphene in a matter of milliseconds using flash Joule heating. Any carbon-containing material can be used as the feedstock for producing flash graphene. This can include waste materials like plastic, food waste, or carbon black. The carbon source is placed between two electrodes in a closed chamber, and an electric current is passed through it. The intense heat generated by the current (up to several thousand degrees Celsius) causes the carbon atoms to rearrange into graphene sheets. The conversion process occurs extremely quickly, typically in milliseconds. This rapid heating and cooling prevents the formation of other carbon structures and results in the formation of high-quality graphene. Flash graphene is highly scalable and can be produced in large quantities. Flash graphene has potential applications in various fields, including energy storage (e.g., batteries, superconductors, etc.), electronics, composite materials, and environmental remediation.

While illustrative exemplary aspects of the technology have been described herein, the present technology is not limited to these aspects, but includes any and all aspects having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A switching apparatus comprising:
an insulator disc comprising one or more openings in the insulator disc;
a front electrode;
a rear electrode, wherein the front electrode and the rear electrode are separated by a gap;
a frame assembly configured to support the insulator disc within the gap; and
a motor configured to rotate the insulator disc within the gap and align the one or more openings in the insulator disc with the front electrode and the rear electrode.

2. The switching apparatus of claim 1, wherein the one or more openings are filled with a compressible or non-compressible fluid having a breakdown voltage relative to dry air of approximately 0.2 to 4.

3. The switching apparatus of claim 1, wherein the one or more openings are filled with a conductive material.

4. The switching apparatus of claim 1, wherein:
the insulator disc further comprises:
one or more magnets on a front face of the insulator disc; and
one or more magnets on a back face of the insulator disc; and
the frame assembly further comprises:
a front magnet post;
a front magnet attached to the front magnet post;
a rear magnet post:
a rear magnet attached to the rear magnet post;
wherein the one or more magnets on the front face of the insulator disc, the one or more magnets on the back face of the insulator disc, the front magnet, and the rear magnet are configured to maintain an alignment of the insulator disc within the gap during operation of the switching device.

5. The switching apparatus of claim 4, wherein the insulator disc further comprises:
a first ring of magnets along an outer edge of the front face of the insulator disc; and
a second ring of magnets along an outer edge of the back face of the insulator disc.

6. The switching apparatus of claim 1, further comprising a motor chair.

7. The switching apparatus of claim 1, wherein insulator disc is comprised of silica materials, ceramics, polymers, or aerogels.

8. The switching apparatus of claim 1, further comprising one or more insulating plates.

9. The switching apparatus of claim 1, wherein the one or more insulating plates is comprised of silica materials, ceramics, polymers, or aerogels.

10. The switching apparatus of claim 1, wherein the motor further comprises a stepper motor.

11. An electrical circuit, comprising:
a switching device comprising:
an insulator disc comprising one or more openings in the insulator disc;
a first electrode;
a second electrode, wherein the first electrode and the second electrode are separated by a gap;
a frame assembly, comprising:
a first electrode post; and
a second electrode post, wherein the frame assembly supports the insulator disc within the gap; and
a motor configured to rotate the insulator disc within the gap and align the one or more openings in the insulator disc with the first electrode and the second electrode;
a power supply supplying voltage to the first electrode; and
a load.

12. The electrical circuit of claim 11, wherein the circuit further comprises a capacitor bank.

13. The electrical circuit of claim 11, wherein the switching device is capable of delivering up to 100V.

14. The electrical circuit of claim 11, wherein the switching device is capable of delivering up to 1 kA.

15. The electrical circuit of claim 11, wherein the switching device is capable of delivering a voltage pulse up to 2 times per second.

16. A method for delivering a voltage pulse in an electrical circuit, comprising:
applying a voltage to a first electrode, the first electrode separated from a second electrode by a gap filled with a compressible or non-compressible fluid;
actuating an insulator door within the gap, the insulator door having one or more openings through the insulator door;
aligning one of the one or more openings in the insulator door with the first electrode and a second electrode;
generating an electrical arc across the gap between the first electrode and the second electrode through the one or more openings in the insulator door;
transmitting electrical power across the electrical arc; and
supplying a voltage pulse to an attached load.

17. The method of claim 16, wherein transmitting electrical power across the electrical arc further comprises triggering the discharge of a capacitor bank within the circuit.

18. The method of claim 16, wherein the duration of the voltage pulse is between 1 microsecond and 500 milliseconds.

19. The method of claim 16, wherein the voltage pulse repeats up to 2 times per second.

20. The method of claim 16, wherein the voltage pulse is between 100V and 80 kV.
